(19) United States
(12) Patent Application Publication
(10) Pub. No.: US 2008/0100131 A1
(43) Pub. Date: May 1, 2008

(54) Hydraulic control method for generating regenerative braking force

(76) Inventors: Gab Bae Jeon, Gunpo-si (KR); Byeong Cheol Yang, Daegu (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,751

(22) Filed: Dec. 29, 2006

(30) Foreign Application Priority Data
Oct. 25, 2006 (KR) 10-2006-0103980

(51) Int. Cl. B60T 8/64

(52) U.S. Cl. 303/152

(57) ABSTRACT

A hydraulic control method for generating a regenerative braking force for a that decreases the reduced amount of a regenerative braking force to increase an energy recovery rate by generating the regenerative braking force directly from the regenerative braking. Such a control method includes steps of measuring a braking force required by a driver; determining where or not the braking force required by a driver is greater than a maximum regenerative braking force; generating an insufficient braking force with a hydraulic braking force, determining where or not the braking force required by a driver is greater than a predetermined reference value; gradually applying a fluid pressure or canceling the fluid pressure by setting a hydraulic braking force entry section; and performing a braking operation only with the regenerative braking force.

### CROSS-REFERENCE TO RELATED APPLICATION

This application claims the benefit of Korean Patent Application No. 10-2006-0103980, filed on Oct. 25, 2006, the entire disclosure of which is hereby incorporated by reference.

### BACKGROUND OF THE INVENTION

1. Field of the Invention

The present invention relates to a hydraulic control method for generating a regenerative braking force in a vehicle and, more particularly, to such a hydraulic control method in that decreases the reduced amount of a regenerative braking force to increase an energy recovery rate by generating the regenerative braking force directly from the regenerative braking.

2. Description of Related Art

In general, a braking system of a vehicle is an important device used for reducing a driving speed of a vehicle, stopping the vehicle and maintaining the stopping state of the vehicle and uses a friction type brake that converts the kinetic energy of the vehicle into thermal energy using frictional force and releases the thermal energy.

Various braking systems have been used and the basic structure thereof comprises an operation mechanism transmitting user's operation force using fluid pressure and a main body receiving the operation force and generating braking force.

A service brake of a foot brake type is mainly used when driving a vehicle and includes a drum brake and a disc brake, which are directed to a method in which a structure of a disc type is connected to an identical structure mounted on the wheel and the disc rotates along with the rotation of the wheel. Accordingly, when the user pushes the brake pedal down, the fluid pressure is transmitted to press both sides of the rotating disc by a friction material such as a disc pad, thus reducing the rotational speed and stopping the vehicle. That is, since the braking system as described above brakes the vehicle by dissipating the rotational energy of the wheels, a significant energy loss occurs.

Recently, various systems and methods for a regenerating braking force have been developed to prevent the energy loss as described above, in which the kinetic energy when braking the vehicle is converted into electric energy and stored in a battery as a charging current, differently from the conventional art in which the kinetic energy of the vehicle is all dissipated to heat of the brake.

In one example, U.S. Pat. No. 6,142,586 has disclosed a braking force control apparatus comprising a hydraulic brake unit for generating a hydraulic braking force, a regenerative brake unit for generating a regenerative braking force, and a brake controller for controlling the hydraulic brake unit so that a driver does not feel uncomfortable due to a discontinuous change in the hydraulic braking force. Moreover, the brake controller controls the hydraulic brake unit so that at least a predetermined fluid pressure is always supplied to a wheel cylinder where a brake operation is performed.

In the above patent, the regenerative braking force is determined as a value subtracting a base hydraulic braking force from a braking force required by a driver (a required braking force). A predetermined portion of the regenerative braking force is supplied to the wheel cylinder and used in maintaining the contact state between a brake pad and a disc rotor, thus preventing a shock generated by the contact or a non-contact between the brake pad and disc rotor. Accordingly, it is possible to prevent the driver from having an unnatural brake feeling due to a discontinuous change in the hydraulic braking force.

Moreover, as depicted in FIG. 2, if a maximum regenerative braking force (F_{Gmax}) is greater than a required braking force (F_{REQ}), the hydraulic braking force (F_{H}) is equal to a hydraulic braking force (F_{H0}) generated when a predetermined fluid pressure (P₀) is supplied to the cylinder wheel, whereas, if the required braking force (F_{REQ}) is greater than the maximum regenerative braking force (F_{Gmax}), the hydraulic braking force (F_{H}) is equal to {F_{H0}+(F_{REQ}−F_{Gmax})}.

However, the above patent has a drawback in that the amount of the regenerative braking force (F_{G}) generated is decreased as much as the applied portion of the hydraulic braking force (F_{H}).

### SUMMARY OF THE INVENTION

Embodiments of the present invention provide a hydraulic control method for a regenerative braking force of a vehicle that decreases the reduced amount of a regenerative braking force to increase an energy recovery rate by generating the regenerative braking force directly from the regenerative braking, not setting a hydraulic braking force separately, but setting a hydraulic braking force entry section to gradually supply or cancel a fluid pressure, thus preventing a shock of a disc and a pad, differently from the conventional art in which a predetermined portion of the regenerative braking force is always used as a hydraulic braking force to maintain the contact state between the disc and the pad.

In an exemplary embodiment of the present invention there is provided a hydraulic control method in generating a regenerating braking force comprising the steps of: measuring a braking force required by a driver; determining where or not the braking force required by a driver is greater than a maximum regenerative braking force; generating an insufficient braking force with a hydraulic braking force, if it is determined that the braking force required by a driver is greater than the maximum regenerative braking force; determining where or not the braking force required by a driver is greater than a predetermined reference value, if it is determined that the braking force required by a driver is smaller than the maximum regenerative braking force; gradually applying a fluid pressure or canceling the fluid pressure by setting a hydraulic braking force entry section, if the braking force required by a driver is less than the maximum regenerative braking force and greater than the predetermined reference value; and performing a braking operation only with the regenerative braking force, if the braking force required by a driver is smaller than the predetermined reference value.

As a further exemplary embodiment, if the braking force required by a driver is 90-110% of the predetermined reference value, the fluid pressure is gradually supplied or canceled by setting the hydraulic braking force entry section.

### BRIEF DESCRIPTION OF THE DRAWINGS

The above and other features of the present invention will be described with reference to certain exemplary embodiments thereof illustrated the attached drawings in which:

FIG. 1 is a graph depicting a regenerative braking force in accordance with the present invention;

FIG. 2 is a graph showing various braking forces in a conventional regenerative braking; and

FIG. 3 is a graph showing a conventional regenerative braking force.

### DETAILED DESCRIPTION OF THE INVENTION

Hereinafter, exemplary embodiments of the present invention will now be described in detail with reference to the attached drawings.

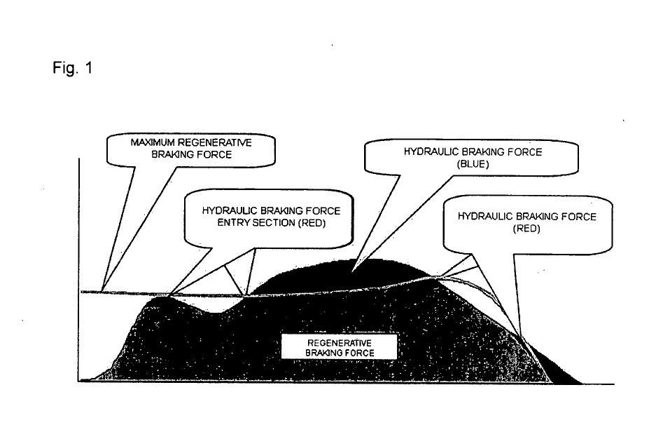

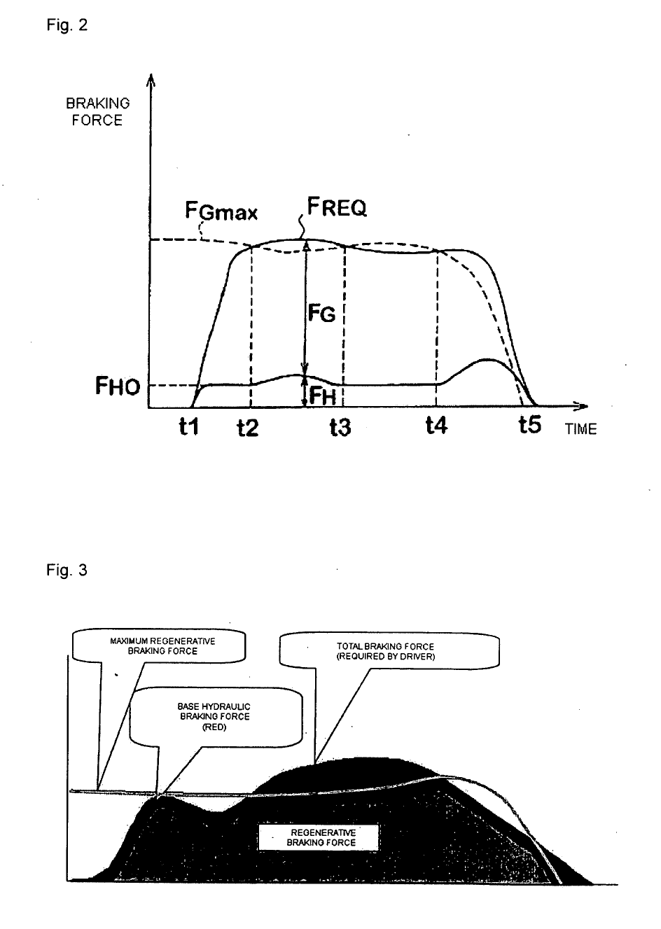

With reference to FIG. 1, it can be seen that embodiments of the present invention can increase an energy recovery rate by generating a regenerative braking force directly from the regenerative braking, not setting a hydraulic braking force separately, but setting a hydraulic braking force entry section to prevent a shock of a disc and a pad.

First, it is determined whether or not the current braking force required by a driver (hereinafter, referred to as a required braking force) is greater than a maximum regenerative braking force. If the required braking force is greater than the maximum regenerative braking force, an insufficient braking force is generated with a hydraulic braking force. If the required braking force is smaller than the maximum regenerative braking force, it may generate the hydraulic braking force. Accordingly, a hydraulic braking force entry section is set to prevent the shock of the disc and the pad. That is, it is determined where or not the required braking force is smaller than the maximum regenerative braking force and greater than a predetermined reference value.

If the required braking force is greater than the reference value, it may cause the hydraulic braking force. Accordingly, the present invention creates a hydraulic braking force entry section to gradually supply or cancel a fluid pressure so that the fluid pressure is constantly generated to prevent the shock of the disc and the pad. Here, it is possible to absorb the shock of the disc and the pad by increasing the fluid pressure gradually. If the required braking force is smaller than the reference value, the braking operation is performed only with the regenerative braking force.

A structure for performing the above described method in accordance with the present invention comprises a hydraulic controller, a hydraulic control execution unit, a regenerative braking controller and a regenerative braking force generator. The controllers utilized with embodiments of the present invention may comprise a processor, memory and associated hardware and software as may be selected and programmed by a person of ordinary skill in the art based on the teachings of the present invention as set forth herein.

As depicted in FIG. 3, if the required braking force is smaller than the maximum braking force, a predetermined portion (red band in the figure) of the regenerative braking force is always used as a hydraulic braking force in the conventional art. However, as shown in FIG. 1, the present invention creates a hydraulic braking force entry section (marked red in the figure) to gradually supply and cancel the fluid pressure, only if the required braking force is 90-110% of the maximum regenerative braking force. Accordingly, it is possible to decrease the reduced amount of the regenerative braking force much more than the conventional art, thus increasing the energy recovery rate

Here, if the required braking force is smaller than 90% of the maximum regenerative braking force, it would not cause any loss by reducing the regenerative braking torque. Meanwhile, if the required braking force is reduced from more than 110% to less than 110%, it may create a buffering section where the hydraulic braking force is generated by reducing the regenerative braking force gradually. Moreover, the shock of the disc and the pad can be absorbed by the hydraulic braking force entry section.

As described above, according to the hydraulic control method in generating a regenerative braking force of a vehicle in accordance with the present invention, it is possible to decrease the reduced amount of the regenerative braking force by creating a hydraulic braking force entry section (marked red in FIG. 1) to gradually supply or cancel the fluid pressure, only if the required braking force is within a range of the maximum regenerative braking force, while a predetermined portion of the regenerative braking force is always used as a hydraulic braking force in the conventional art, if the required braking force is smaller than the maximum regenerative braking force, thus increasing the energy recovery rate.

Moreover, it is possible to absorb the shock of the disc and the pad through the hydraulic braking force entry section.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. A hydraulic control method in generating a regenerating braking force, comprising:
measuring a braking force required by a driver;
determining where or not the braking force required by a driver is greater than a maximum regenerative braking force;
generating an insufficient braking force with a hydraulic braking force, if it is determined that the braking force required by a driver is greater than the maximum regenerative braking force;
determining where or not the braking force required by a driver is greater than a predetermined reference value, if it is determined that the braking force required by a driver is smaller than the maximum regenerative braking force;
gradually applying a fluid pressure or canceling the fluid pressure by setting a hydraulic braking force entry section, if the braking force required by a driver is less than the maximum regenerative braking force and greater than the predetermined reference value; and
performing a braking operation only with the regenerative braking force, if the braking force required by a driver is smaller than the predetermined reference value.

2. The hydraulic control method in generating a regenerating braking force as recited in claim 1, wherein, if the braking force required by a driver is 90-110% of the predetermined reference value, the fluid pressure is gradually supplied or canceled by setting the hydraulic braking force entry section.
